(19) United States
(12) Patent Application Publication
(10) Pub. No.: US 2018/0300696 A1
(43) Pub. Date: Oct. 18, 2018

(54) SYSTEM AND METHOD FOR REDISTRIBUTION OF FUNDS ACCORDING TO SPENDING PATTERNS

(71) Applicant: Xerxes Dotiwalla, Union City, NJ (US)

(72) Inventor: Xerxes Dotiwalla, Union City, NJ (US)

(21) Appl. No.: 15/494,477

(22) Filed: Apr. 22, 2017

Related U.S. Application Data
(60) Provisional application No. 62/485,950, filed on Apr. 16, 2017.

(51) Int. Cl. G06Q 20/10; G06Q 40/00

(52) U.S. Cl. CPC G06Q 20/10; G06Q 40/00

(57) ABSTRACT

A system and method that induces the user to change his or her spending habits, by transferring a sum of money from a Source Account to a Target Account, according to spending that has been determined by the user to be wasteful.

### FIELD OF THE INVENTION

The present invention, in at least some embodiments, is of a system and method for redistribution of funds according to spending patterns, and in particular, to such a system and method of transferring funds according to user-designated spending categories.

### BACKGROUND OF THE INVENTION

Three of the worst American money habits are: too much wasteful spending, too much debt, and too little saving. Budgeting and controlling spending is known to be difficult for individuals, and may be particularly difficult for individuals just starting out in employment. Various tools have been suggested for controlling such spending, including software tools. However such tools typically revolve around setting budgets and hoping the user sticks to them.

Simply categorizing spending is also not sufficient. The user may be well aware that a significant amount of money is going toward entertainment, for example, or at least toward spending that the user considers to be non-essential. However simply knowing that such aggregate spending amounts are large does not serve to change the user's spending behavior.

U.S. Pat. No. 7,945,512 describes a system that includes a Spending Account and a savings account, as well as the ability to dictate which type of payments can be made from each account.

US20050261968 is similar in that it describes a restricted medical savings account, which can only be used to purchase certain types of eligible items.

US20120278148 describes budgeting software which operates to help users track spending.

### BRIEF SUMMARY OF THE INVENTION

The background art does not teach or describe a system or method that induces the user to alter his or her spending, while at the same time automating saving, paying down debt, or investing

By contrast, the present invention, in at least some embodiments, provides a system and method that induces the user to change his or her spending habits, by transferring a sum of money from a Source Account to a Target Account, according to spending that has been determined by the user to be wasteful.

Essentially, it solves the three worst money habits mentioned above (too much wasteful spending, too much debt, and too little saving) by tying them together. When it detects wasteful spending, it “penalizes” the user by automatically saving a commensurate amount. Of course, this “penalty” is really for the good of the user anyway.

Unless otherwise defined, all technical and scientific terms used herein have the same meaning as commonly understood by one of ordinary skill in the art to which this disclosure belongs. The materials, methods, and examples provided herein are illustrative only and not intended to be limiting.

Various embodiments of the methods, systems and apparatuses of the present disclosure can be implemented by hardware and/or by software or a combination thereof. For example, as hardware, selected steps of methodology according to some embodiments can be implemented as a chip and/or a circuit. As software, selected steps of the methodology (e.g., according to some embodiments of the disclosure) can be implemented as a plurality of software instructions being executed by a computer (e.g., using any suitable operating system). Accordingly, in some embodiments, selected steps of methods, systems and/or apparatuses of the present disclosure can be performed by a processor (e.g., executing an application and/or a plurality of instructions).

Although embodiments of the present disclosure are described with regard to a “computer”, and/or with respect to a “computer network,” it should be noted that optionally any device featuring a processor and the ability to execute one or more instructions is within the scope of the disclosure, such as may be referred to herein as simply a computer or a computational device and which includes (but not limited to) any type of personal computer (PC), a server, a cellular telephone, an IP telephone, a smartphone, a PDA (personal digital assistant), a thin client, a mobile communication device, a smartwatch, head mounted display or other wearable that is able to communicate wired or wirelessly with a local or remote device. To this end, any two or more of such devices in communication with each other may comprise a “computer network.”

### BRIEF DESCRIPTION OF THE DRAWINGS

Embodiments of the disclosure are herein described, by way of example only, with reference to the accompanying drawings. With specific reference now to the drawings in detail, it is stressed that particulars shown are by way of example and for purposes of illustrative discussion of the various embodiments of the present disclosure only, and are presented in order to provide what is believed to be a useful and readily understood description of the principles and conceptual aspects of the various embodiments of inventions disclosed therein.

FIG. 1A shows an exemplary high level architecture of a system according to at least some embodiments of the present invention;

FIG. 1B shows an exemplary non limiting illustrative backend software architecture showing Spending Adjustment Backend Software 101 in greater detail along with some of the components with which it communicates;

FIG. 1C shows an exemplary non limiting client software architecture which shows a non limiting exemplary architecture for Spending Adjustment Client Software 102;

FIG. 1D shows the New User Flow in greater detail from FIG. 1C for operation in the client software;

FIG. 2A is a non limiting exemplary flow for internal engine rules;

FIG. 2B shows a non-limiting exemplary flow for internal engine rules with regard to a wasteful example;

FIG. 2C shows a non-limiting exemplary flow for internal engine rules with regard to a non-wasteful example;

FIG. 2D shows a non-limiting exemplary flow for internal engine rules with regard to a wasteful example, but with a low source account balance;

FIG. 3A shows a non-limiting example of an initially user setup flow;

FIG. 3B shows an initial user setup flow as a non-limiting example specific parameters;

FIG. 4 shows a non-limiting exemplary periodic spending checker flow;

FIG. 5A shows an example of wasteful categories, such as for example, bank fees; and

FIG. 5B shows a non-limiting set of example transactions from the Spending Account API.

### DESCRIPTION OF AT LEAST SOME EMBODIMENTS

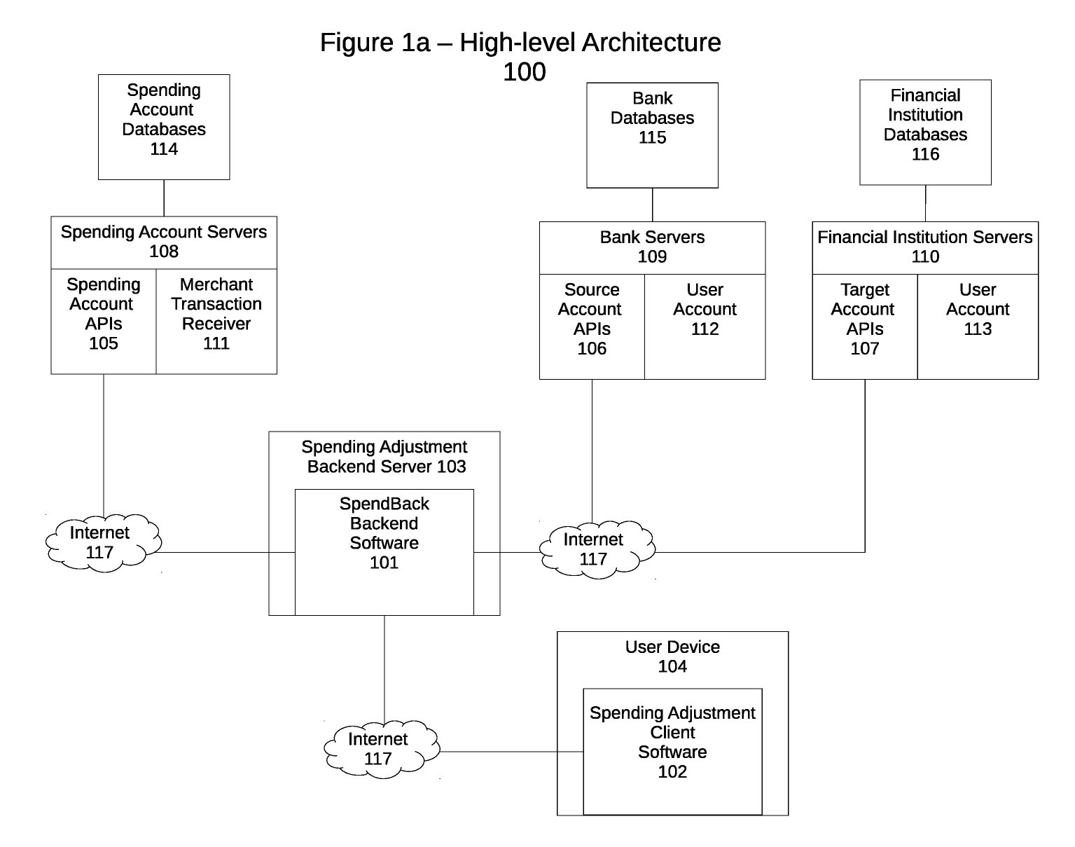

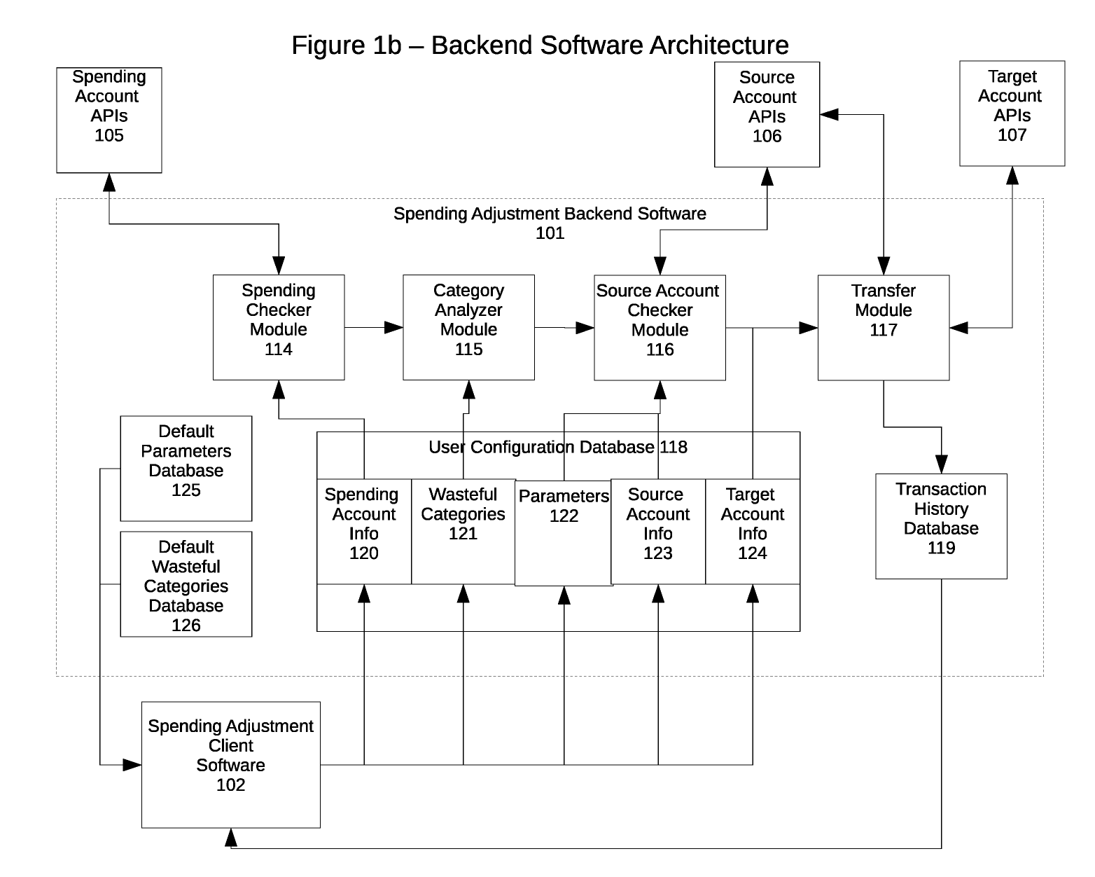

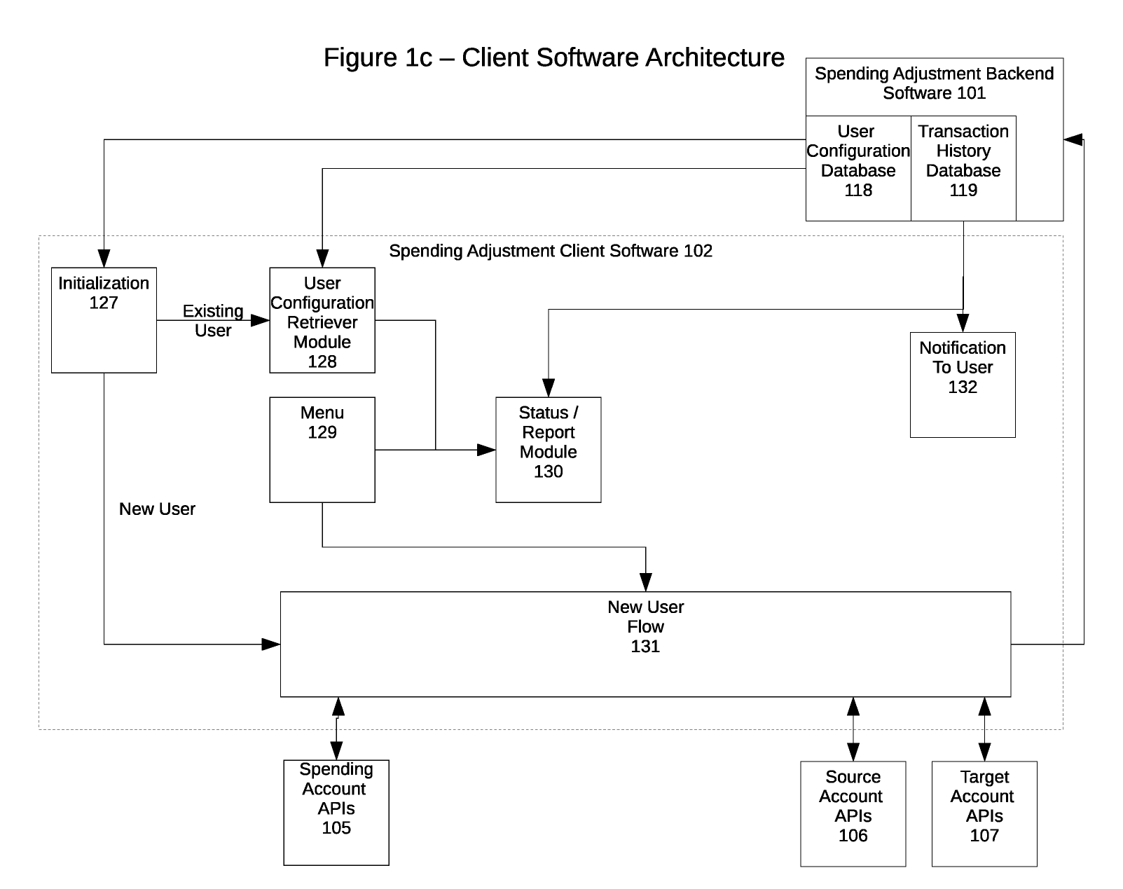

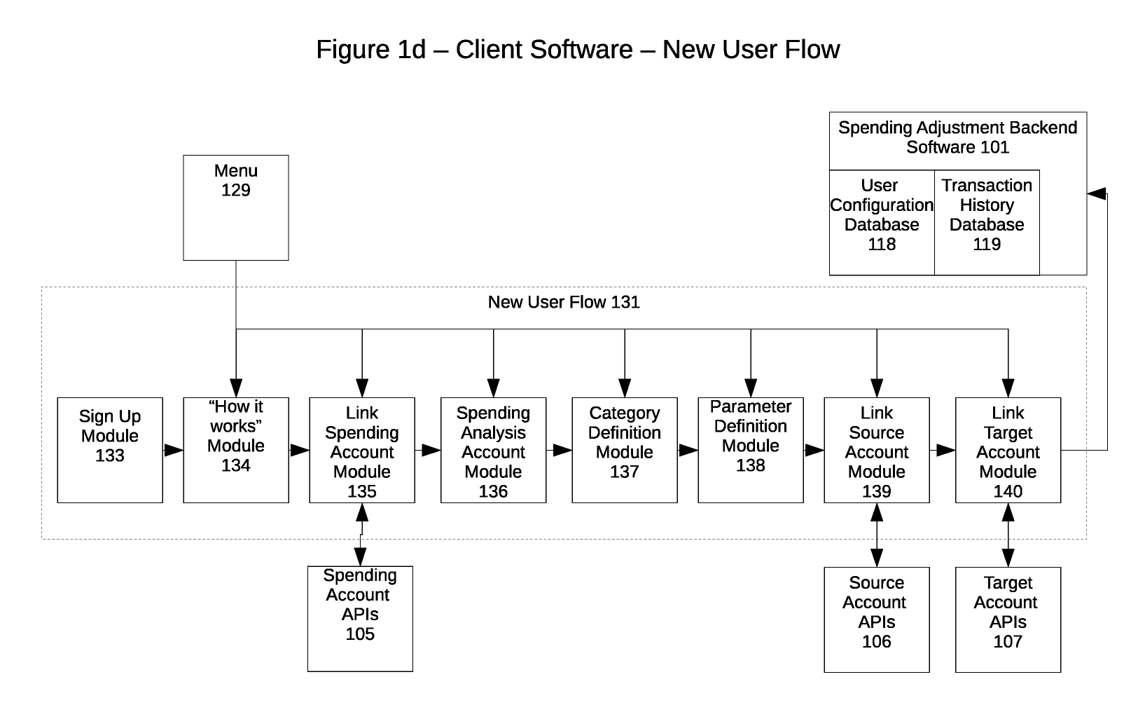

Turning now to the drawings, there is shown in FIG. 1A an exemplary high level architecture of a system according to at least some embodiments of the present invention. As shown a system 100 according to least some embodiments of the present invention features a User Device 104, operating a Spending Adjustment Client Software 102. Spending Adjustment Client Software 102 enables the user to interact through User Device 104 with a Spending Adjustment Backend Server 103, operating a Spending Adjustment Backend Software 101. Spending Adjustment Backend Server 103 communicates with User Device 104 through a computer network such as the internet shown as a Computer Network 117.

Spending Adjustment Backend Software 101 communicates with and receives information from various different servers and databases. All such communication is shown as occurring through a Computer Network 117. Spending Adjustment Backend Server 103 is in communication with one or more Spending Accounts Servers 108. Spending Account Servers 108 may optionally comprise any type of server, such as for example a credit card server, a server from a merchant, or any other type of server which provides information in regard to money that is spent by the user who operates User Device 104. As another non-limiting example, such servers may optionally be accessed through a data provision service, such as Plaid or Dwolla, which provide Spending Account data. Within Spending Account Server 108, optionally information is obtained from one or more Spending Account Databases 114, such as which transactions are performed according to the name or other identifier of the user which is in turn also provided to Spending Adjustment Backend Software 101 and to Spending Adjustment Clients Software 102. Spending Account Database 114 also relates to such information as which credit card or credit cards are used, which merchant transactions occur, what the merchant transactions are for, such as for example food versus clothes or any other type of spending category, and also the date on which the transaction occurs.

The Spending Account can either be a credit card or a debit card, which may, for example, be linked to a checking account. In the latter case, it would be possible for the Spending Account to also be the Source Account from which funds are transferred as described in greater detail below.

In order for Spending Adjustment Backend Server 103 to obtain this information for analysis for Spending Adjustment Backend Software 101, Spending Adjustment Backend Server 103 communicates with one or more Spending Account APIs 105. Spending Account APIs 105 enable transactions through accounts from credit card companies and or directly from merchant transactions, according to the type of Spending Account as described above. The merchant transaction information is in turn provided to a Merchant Transaction Receiver 111.

On the other hand, Spending Adjustment Backend Server 103 is also in communication with one or more servers which relate to sources of money controlled by the user and Target Accounts. Both of these different types of accounts are optionally and preferably bank accounts, credit card accounts, savings accounts, any type of account in which money may be moved into the account by the user or withdrawn from the account by the user. Again, the user operating through Spending Adjustment Client Software 102 identifies these accounts, the numbers and provides access to Spending Adjustment Backend Server 103 such that Spending Adjustment Backend Software 101 is able to communicate with these servers though Computer Network 117. As a non limiting example of these servers having accounts with which Spending Adjustment Backend Server 103 may communicate are Bank Servers 109 and Financial Institution Servers 110. Bank Servers 109 may optionally control or interact with any type of bank information for any type of bank account operated by the user.

As shown, preferably Spending Adjustment Backend Server 103 communicates with Bank Servers 109 through one or more Source Account APIs 106. These allow Spending Adjustment Backend Server 103 to submit queries to Bank Servers 109 and to obtain information therefrom. Bank Servers 109 also comprise a User Account 112, the information about which may be stored in Bank Databases 115. Again, Spending Adjustment Backend Software 101 needs to access the information in Bank Databases 115 regarding User Account 112, and so Spending Adjustment Backend Server 103 accesses either User Account 112 directly and or information about User Account 112 through Bank Databases 115 through communicating with Source Account APIs 106.

Another type of account server with which Spending Adjustment Backend Server 103 may actually communicate are Financial Institution Servers 110. Financial Institution Servers 110 may for example connect to accounts including but not limited to checking, savings, brokerage, IRA, credit card, and so forth, represented as a User Account 113. Such accounts are non-limiting examples of Target Accounts—potential recipients of funds. In the case of Bank Servers 109, a Source Account API 106 allows Spending Adjustment Backend Server 103 to obtain information about a User Account 112 as Source Account. By Source Account it is meant that funds may be obtained from User Account 112, to be paid to the previously described Target Account. User Account 112 is expected to be for example a checking or savings account.

For this non limiting example, depending upon the type of purchases the user made through Spending Account Servers 108, the user may allow the Spending Adjustment Client Server 102 and hence Spending Adjustment Backend Software 101 to withdraw money from a Source Account. In this non limiting example User Account 112 is a Source Account. If the money is withdrawn from the Source Account then it is to be paid to a Target Account. In this non limiting example, a User Account 113 that can be accessed through a Financial Institution Server 110 is the Target Account, hence Spending Adjustment Backend Server 103 communicates with Financial Institution Servers 110 though one or more Target Account APIs 107. Information about User Account 113 may also optionally be obtained from Financial Institution Databases 116.

FIG. 1B shows an exemplary non limiting illustrative backend software architecture showing Spending Adjustment Backend Software 101 in greater detail along with some of the components with which it communicates. As previously noted, Spending Adjustment Backend Software 101 communicates with Spending Account APIs 105, Source Account APIs 106, and Target Account APIs 107. Spending Adjustment Backend Software 101 also communicates with Spending Adjustment Client Software 102 which is operated by the previously described User Device and with which the user interacts in order to provide information. The type of information which the user provides through Spending Adjustment Client Software 102 preferably includes the identity of one or more Spending Accounts which may then be accessed through Spending Account APIs 105. As previously noted, the Source Accounts are intended for withdrawal of funds if wasteful spending is detected, accessible through Source Account APIs 106. The user also provides information about one or more Target Accounts. These are accounts which receive money withdrawn from the Source Account if spending has been determined to be wasteful. Target accounts are accessed through Target Account APIs 107.

In terms of the flow, Spending Adjustment Client Software 102 communicates such information as the Spending Account Information 120 as previously described, so that Spending Adjustment Backend Software 101 is able to communicate with Spending Account APIs 105. Such information optionally and preferably includes the account number, the holder of the account, any type of user ID or password or any other authentication information which would be required for Spending Adjustment Backend Software 101 to access this information. In addition, Spending Adjustment Client Software 102 provides information regarding Categories of Wasteful Spending 121. These are categories of spending which the user either considers to be wasteful, wishes to cut down on, or otherwise wishes to discourage. Non limiting examples of such Wasteful Categories 121 while described in greater detail may include for example spending on certain types of food, perhaps restaurant food, perhaps fast food, and or certain types of food items such as alcohol and or alcohol when purchased at certain establishments, smoking or tobacco products in general, and indeed any other categories which the user wishes to discourage. Spending Adjustment Client Software 102 also optionally stores Parameters 122, for example, how much to transfer from source to Target Account and under what circumstances.

Spending Adjustment Client Software 102 also stores Source Account Information 123 and Target Account Information 124 again as previously described. This allows Spending Adjustment Backend Software 101 to interact with Source Account APIs 106 and Target Account APIs 107 respectively. Again, such information is provided to allow Spending Adjustment Backend Software 101 to access the user accounts, including the number of the account, the name of the account or of the holder, the institution holding the account, any optional information regarding the server, and or any other type of user authentication. All of these different types of information are stored in User Configuration Database 118. From User Configuration Database 118, this information in turn goes to a Spending Checker Module 114.

Spending Checker Module 114 checks with Spending Account APIs 105 to determine how the user is spending money. For example, whether directly with merchants, with PayPal, with credit cards, with any other way in which to spend money. Spending Checker Module 114 is typically only able to interact with Spending Account APIs 105 when payment is made electronically. If payment is made in some other mode such as for example cash, spending checker module 114 may instead receive the information manually from the user through the Spending Adjustment Client Software 102.

Next, after spending information is obtained by Spending Checker Module 114, the information goes to a Category Analyzer Module 115 to determine the categories of spending. In particular, Category Analyzer Module 115 receives information regarding Wasteful Categories 121 from User Configuration Database 118. In this non limiting example Category Analyzer Module 115 determines which spending is considered to be wasteful according to Wasteful Categories 121 and then places all other types of spending into a non wasteful category, which is not shown. Optionally, Category Analyzer Module 115 only analyzes spending in the wasteful category as determined as Wasteful Categories 121.

Next, after the categories have been analyzed, the information is then provided to a Source Account Checker Module 116. This is because the user through Spending Adjustment Client Software 102 would have indicated to Spending Adjustment Backend Software 101 how much money should be withdrawn from a Source Account through Source Account APIs 106 if that money is spent in what is determined to be a wasteful category by Category Analyzer Module 115. Source Account Checker Module 116 obtains parameters from 122 for example according to what is the minimum account balance in the Source Account that needs to be obtained or provided before money is transferred, and any other conditions which the user wishes to places on such a transfer. Source Account Checker Module 116 also obtains information about the Source Account from Source Account Info 123. If it turns out that a withdrawal is to be made from the Source Account according to Parameters 122 and also according to Category Analyzer Module 115 in terms of wasteful spending, then Source Account Checker Module 116 communicates with Source Account API 106 to initiate the transfer.

Source Account Checker Module 116 then provides this information to a Transfer Module 117 which obtains information from Target Account Information 124 and is able to communicate both with a Target Account through a Target Account API 107, and the Source Account through the Source Account API 106 to cause the transfer to occur. In this way, a sum of money is transferred from the Source Account to the Target Account according to the amount of spending that is considered to be wasteful and also optionally according to one or more Parameters 122, such as the minimum account balance which will be present in the Source Account for this to occur. Optionally, a percentage of such funds would be withdrawn as a transaction fee, so that the amount received in the Target Account would be less this fee.

Next, after effecting transfer or not effecting transfer according to the parameters and according to whether such a transfer may be made according to the user preferences, Transfer Module 117 then indicates whether a transfer occurred and for how much in Transaction History Database 119.

FIG. 1C shows an exemplary non limiting client software architecture which shows a non limiting exemplary architecture for Spending Adjustment Client Software 102. As previously described, Spending Adjustment Client Software 102 is operated by the User Device. Spending Adjustment Backend Software 101 in particular User Configuration Database 118 and User Transaction History Database 119 communicates with Spending Adjustment Client Software 102. User Configuration Database 118 provides information to an Initialization Module 127 which will either determine that the user is a new user in which case the process proceeds to a New User Flow 131 described in greater detail below, alternatively determines that the user is an existing user, login is affected and or a session is initiated in which Spending Adjustment Backend Software 101 communicates with Spending Adjustment Client Software 102. User Configuration Retriever Module 128 retrieves information from User Configuration Database 118 as previously described.

Next, this information is optionally provided in a Status/Report Module 130. Transaction History Database 119 may also provide information in terms of a notification to User Module 132 which may for example optionally include a dashboard. Both Status/Report Module 130 and Notification To User Module 132 may optionally include a dashboard, some type of messaging though the user, whether through SMS, WhatsApp, or some other messaging parameter, or may simply optionally display the information to the user when the user happens to open up Spending Adjustment Client Software 102. In addition, for the new user flow to occur, Spending Account APIs 105 need to be connected to New User Flow 131. Source Account APIs 106 need to be connected through New User Flow 131 and Target Account APIs 107 need to be connected through New User Flow 131.

Menu 129 enables an existing user to revisit any portion of the new user flow (setting parameters, accounts, etc) to change such parameters, accounts and other information.

FIG. 1D shows the New User Flow in greater detail from FIG. 1C for operation in the client software. New User Flow 131 as shown features interactions from a Menu 129, and optionally includes the following flow. First the user signs up through a Signup Module 133, in which the user provides such information as a preferred user email address, password and username. Next the user reviews the How It Works Module 134 in order to understand what type of information is provided and how it needs to be provided. Next, the user links the Spending Account Module in stage 135. This for example could include any type of Spending Account as previously described. Such a connection then enables the flow to continue through Spending Account APIs 105 so that the final connection is made and is enabled for Spending Adjustment Backend Software 101. The flow continues with 136 in which Spending Account Analysis Module performs an analysis of spending made by the user, for example credit card spending or any other type of spending. Again, preferably related particularly to electronic means of spending such as PayPal, credit cards, direct bank transfers and the like and of course debits cards.

Next, a Category Definition Module 137 is operative to determine what types of categories are considered to be categories of wasteful spending. For example, typically not all food will be considered to be wasteful spending, but some types of food might be, perhaps alcohol, perhaps food bought at all restaurants or only food bought at certain types of restaurants such as fast food restaurants, or perhaps any spending at a category of establishment known as a bar. After the categories have been defined for wasteful spending, then the parameters are defined in Parameter Definition Module 138. These include for example: what is the minimum amount of money that needs to be present in the Source Account in order for a money transfer to be affected? How much is the maximum amount that can be transferred? What is the minimum amount that should be transferred? Any other parameters that the user wishes to set for transfer of money.

Next, the Source Account Module 139 is linked through Source Account APIs 106, and then the Target Account Module 140 is linked through Target Account APIs 107. The flow then ends with Spending Adjustment Backend Software 101 which now has all of the information necessary for the new user to be able to affect the user flow for handling wasteful spending.

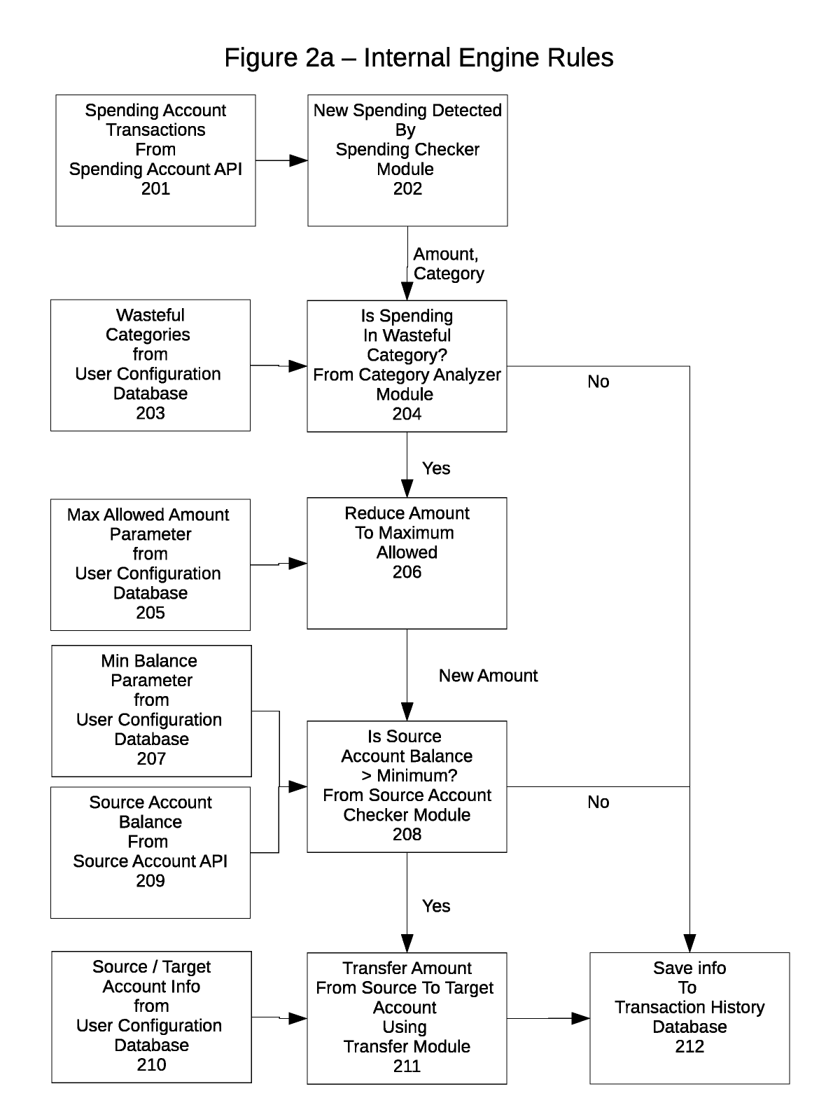

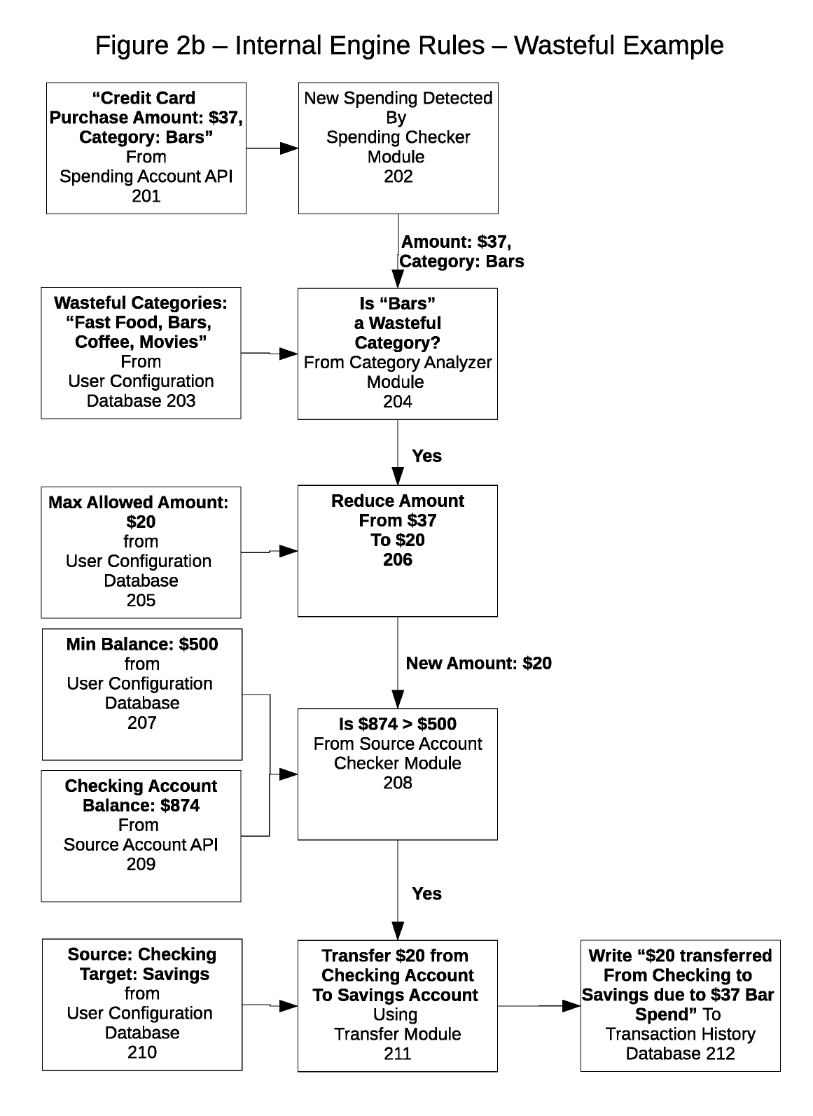

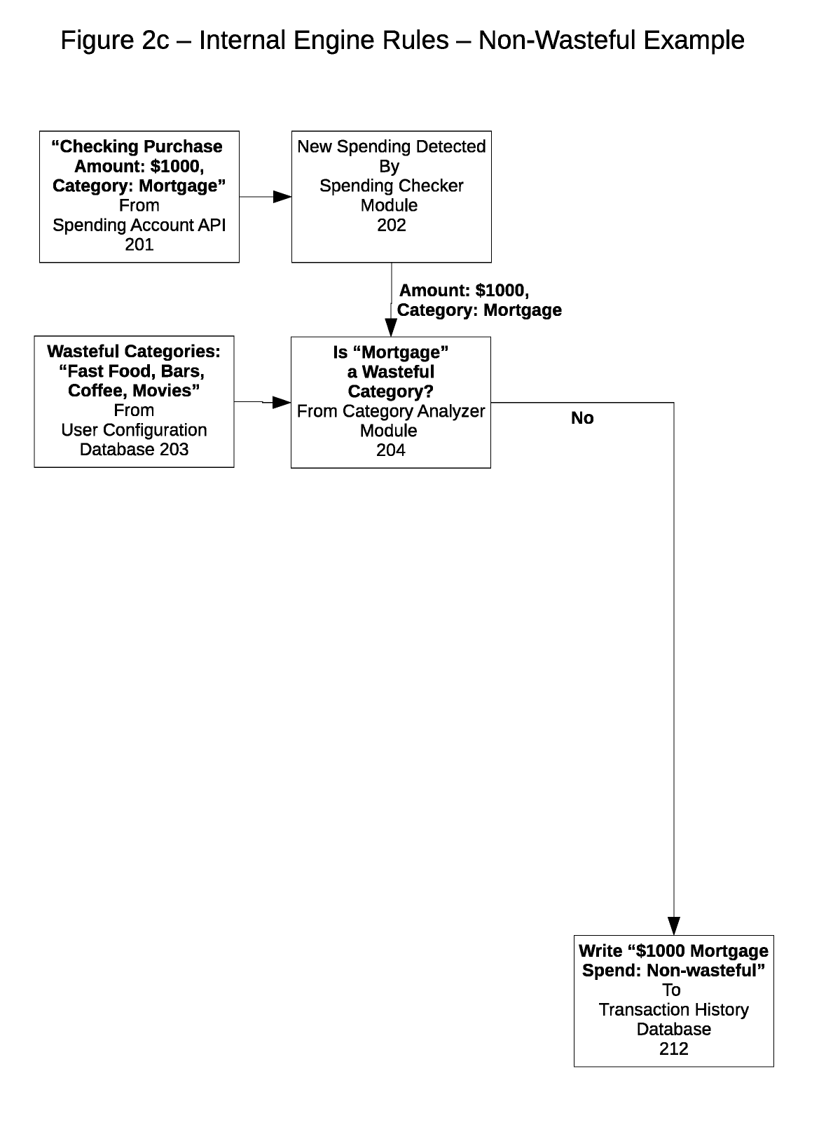

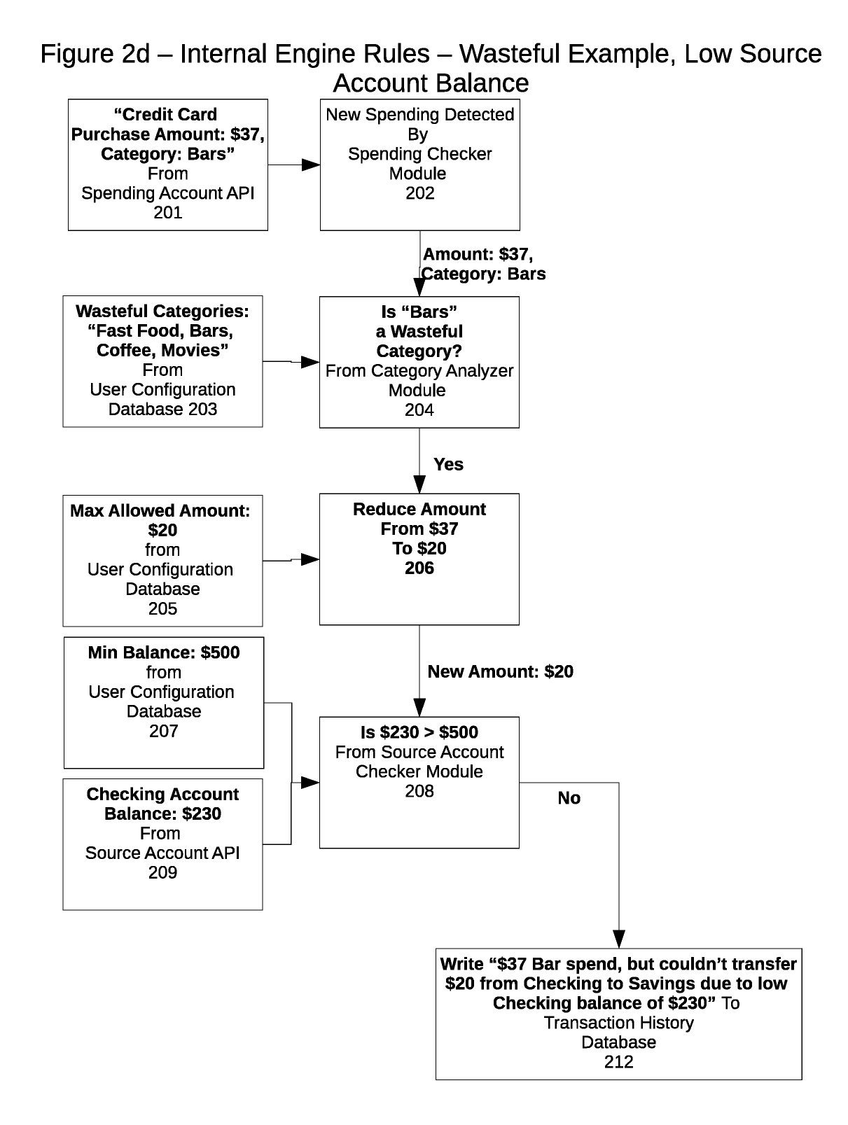

FIG. 2A is a non limiting exemplary flow for internal engine rules. In Module 201 Spending Account transactions are obtained though the Spending Account API. Next, new spending is detected by the Spending Checker Module 202. The amount in each category is detected. Now, in particular the category is preferably analyzed to the depth requested by the user, so for example if the user wishes to categorize all restaurant spending or all spending on food prepared outside the house as restaurant spending, then only categories in regards to restaurant spending will be made, but if the user wishes to have more granularity such as for example fast food restaurants, optionally such information is provided through the Spending Account API. Alternatively, if the degree of granularity desired by the user is not available through such spending information, then the information would need to be obtained regarding what does it mean to be a fast food restaurant. The user for example could have been optionally provided with a set of choices of typical fast food restaurants, but the user could also optionally write in restaurant names that are considered to be fast food.

Once the amount in categories has been determined, it is determined whether the spending appears in a wasteful category. First, wasteful categories from the User Definition Database are loaded in stage 203 and then the Category Analyzer Module determines whether the spending is in a wasteful category in stage 204. If the answer is no, then the process proceeds to saving information to Transaction History Database 212, but actually no action is to be taken because the spending is not considered to be wasteful. If the spending is considered to be wasteful, then the amount is reduced to the maximum allowed in stage 206. The maximum allowed is determined according to the max allowed amount parameter from the User Configuration Database in stage 205, and by maximum allowed, this is the maximum amount allowed which could be transferred.

Once this amount has been obtained, then information is obtained in stage 207 according to the minimum balance parameter from the User Configuration Database, and it is determined whether the Source Account balance is above the minimum in stage 208 from this Source Account Checker Module 208. If the answer is no, then again the information is saved to the Transaction History Database 212, although optionally notification is made to the user. If the answer is yes, then the amount is transferred from the source to Target Account using the Transfer Module in stage 211. In order for this to occur, the Source Account information is obtained as well as the Source Account balance from the Source Account API 209. Then the target information is obtained from the User Account Configuration Database 210, and all this is provided in stage 211 to allow the transfer to be made (optionally minus a transaction fee as previously described).

Turning now to FIG. 2B, there is shown a non-limiting exemplary flow for internal engine rules with regard to a wasteful example. Now by wasteful example it is meant an example of a spending flow in which the user has performed spending which is detected in one of these accounts, such as a credit card account, which the user has previously deemed to be wasteful through the software module operated by the User Device. So in this case in stage 201, a credit card purchase amount is determined to be $37 in this non-limiting example, the credit card is an example of a Spending Account. The purchase amount of $37 is found to be in the category bars. This is obtained from the Spending Account API. In stage 202, new spending is detected by the Spending Checker Module. This may occur as a pull from the Spending Account API or as a push. Once the spending has been detected, it is analyzed to determine the amount, which in this case is $37 and also the category of spending, which in this case bars.

For the category analyzer module to determine whether bars is a wasteful category, this module must retrieve information about wasteful categories from the User Configuration Database in stage 203. In this non-limiting example, wasteful are considered to be purchases on fast food, bars, coffee or movies. Now the category analyzer module in stage 204 determines that bars is considered to be a wasteful category of spending. As bars has been determined to be a wasteful category of spending, now in stage 206, it is considered what amount may be transferred, from the Source Account to the Target Account. (Optionally, the user could choose to have this potential transfer amount scaled, for example by being increased or decreased. As a non-limiting example, the user could choose to have this amount reduced by 50%.)

Turning back to the current example, the maximum allowed amount for a transfer of $20 is retrieved from the user configuration database in stage 205. Of course such a maximum allowed amount is optional and it may be that the user would not want to have a maximum allowed amount. In this case where the user has specified the maximum allowed amount, in stage 206 the actual amount of spending is reduced from $37 to $20. This is the new amount, which may potentially then be transferred. Now, however the Source Account Checker Module obtains two pieces of information.

First, it is determined whether there is minimum balance, which needs to be present in the Source Account for any transfer to occur. In this non-limiting example, the minimum is found to be $500. This information is obtained from the User Configuration Database in stage 207. Next, the Source Account Checker module needs to check the actual balance in the Source Account, which in this non-limiting example is a checking account. Using the Source Account API in stage 209 it is determined that this checking account balance is $874. Therefore, in stage 208, the Source Account Checker module determines whether the amount in a checking account is greater than the minimum required amount. In this case, $874 is greater than $500 and so the answer is yes.

Now, the source (checking) and target (savings) account info is retrieved from the User Configuration Database in stage 210. This information is then provided to the transfer module in stage 211, which indicates the $20 has to be transferred from the Source Account, the checking account, to a Target Account, which in this non-limiting sample is a savings account, using the Transfer Module.

Next, the transaction history database is updated in stage 212, with $20 being transferred from checking to savings due to the $37 bar spend to indicate the total amount of the wasteful category of spending as well as the amount transferred.

Turning now to FIG. 2C, there is shown an example of the flow for internal engine rules, but for spending that does not fall into a wasteful category. As previously described, at the setup and optionally also at further points, the user defines which spending categories are wasteful. Categories not labelled as wasteful are assumed to be non-wasteful. In stage 201, from the Spending Account API, it is determined, that there has been a checking purchase in the amount of $1,000 for the category of mortgage. Again, in stage 202, new spending is detected by the Spending Checker Module. The spending is analyzed to determine the amount, $1,000 in the category which is mortgage.

Again, the Category Analyzer Module obtains information about wasteful categories from the User Configuration Database in stage 203. Again, for this non-limiting example, wasteful categories are considered to be purchases of fast food, purchases in bars, purchases of coffee and purchases of or at the movies. Category analyzer module in stage 204 then asks whether mortgage is a wasteful category. As mortgage does not match any of the previously determined categories of wasteful spending, stored in the configuration database, then in stage 204, mortgage is not determined to be a wasteful category. Therefore in stage 212, the transaction history database receives an instruction to write $1,000 of mortgage spent as being non wasteful.

It is possible, of course, for certain amounts to be categorized in a Spending Account or through a credit card or through any other type of Spending Account as not being wasteful, simply because they were not previously described as being a wasteful category. The user can always view the transaction history database, as previously described, for example through a dashboard, and can always choose to assign certain types of additional spending to a wasteful category. FIG. 2D shows a non-limiting exemplary flow, for internal engine rules, in which an example has been provided of wasteful spending, but the Source Account balance is low. So again, in stage 201, from the Spending Account API, a credit card purchase amount of $37 is detected in the category of bars. Spending Checker Module, again in 202 detects the spending, the amount is considered to be $37, the category is bars, wasteful categories are obtained from the user configuration database in stage 203 and the category analyzer module in stage 204, again determines that bars are considered to be a wasteful category. Again in stage 205, the maximum allowed amount of $20 for any particular transfer is obtained from the user configuration database and so in stage 206, the amount is reduced from $37 to $20. Now the new amount for the transfer is $20. In stage 207, the minimum balance, that needs to be present in the Source Account is obtained from the user configuration database, in this case $500. The actual Source Account balance is obtained from the Source Account API in stage 209 in this case $230 in their checking account.

The Source Account checker module in stage 208 determines that $230 is actually not greater than $500, so instead of performing the transfer, the transaction history database is updated to indicate a $37 bar spend was detected, but couldn't transfer $20 from checking to savings due to a low checking balance of $230 to the transaction history database.

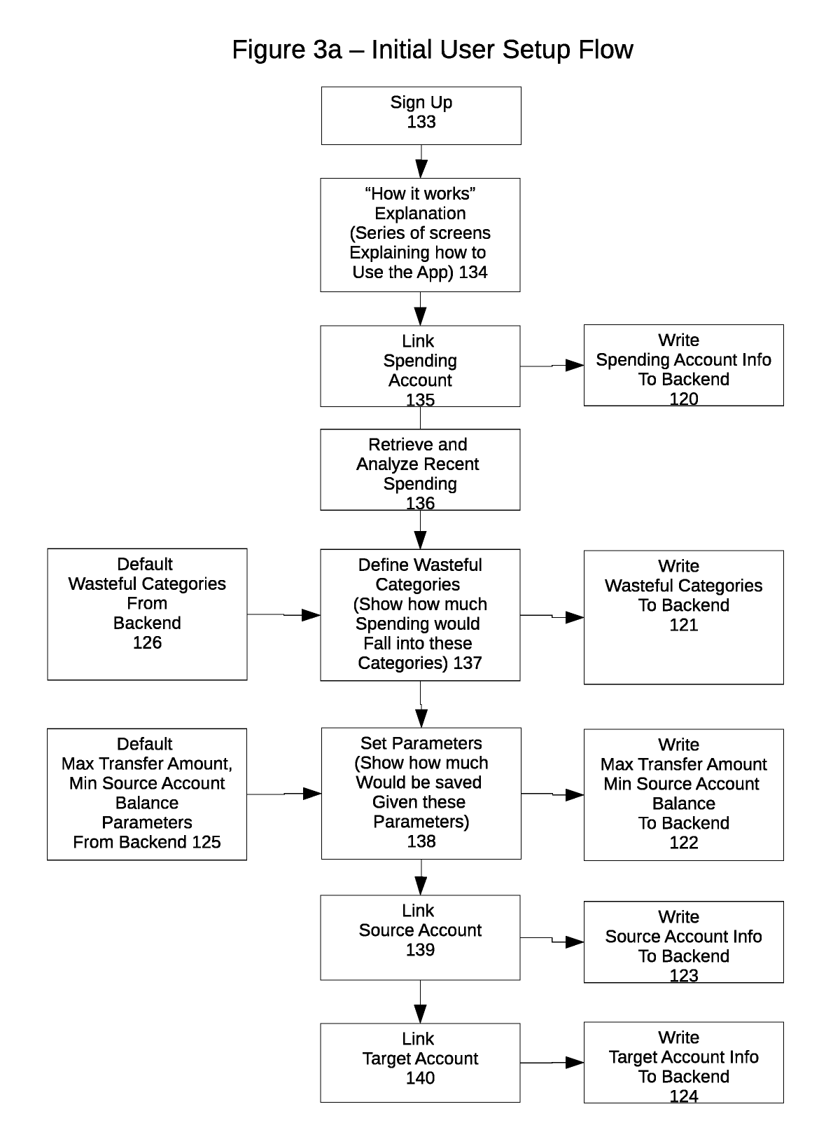

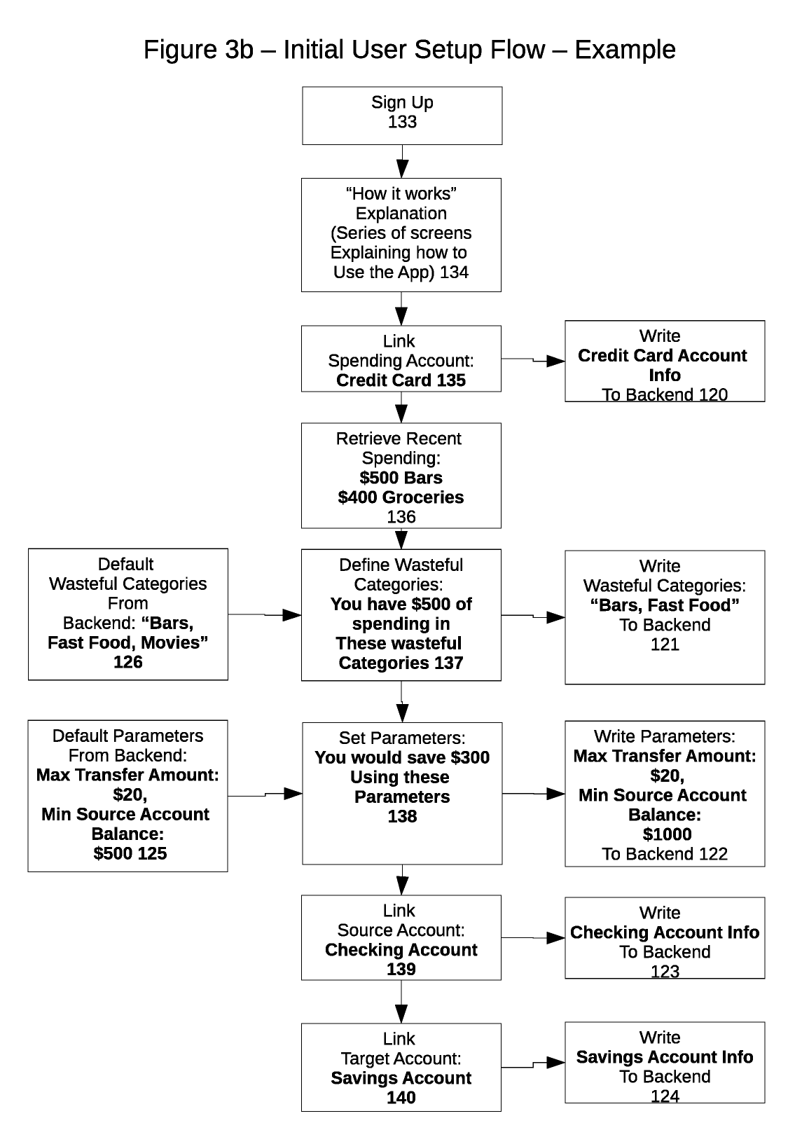

FIG. 3A shows a non-limiting example of an initially user setup flow. In stage 133, the user begins by signing up. Next, a series of screens explaining how to use the app is provided in stage 134. One or more Spending Accounts are linked in stage 135 and the Spending Account information is written to the back end in stage 120. Recent spending is retrieved and analyzed in stage 136, to help the user assign spending to different categories, to help the user determine where they are spending a lot of money, such as for example perhaps the user is spending a lot of money at one particular establishment.

Now if that establishment is a grocery store, then the app might simply ask the user perhaps to further gradually determine what the user is actually spending at the grocery store, for example by providing a scan of an actual receipt and then the app might try to help the user determine within that overall scan, what the categories are. But perhaps the establishment is a bar or some other establishment, the user would then be encouraged to determine whether their spending is wasteful or not. Default wasteful categories are provided from the back end in stage 126. So these for example might be wasteful categories of spending, or spending that others have considered to be wasteful whether loaded in due to a predetermined set of categories, perhaps learning from other users, perhaps learning from users from some other demographics, but in any case these default categories are provided.

The app then suggests that these categories might be considered to be wasteful categories. The amount of spending that is determined to fall into these categories in stage 137 is calculated by looking at recent purchases in 136 and their corresponding categories. The user is then encouraged to alter the wasteful categories as necessary, optionally to change certain spending categories for example to become considered as wasteful or not wasteful. The wasteful categories are then written to the back end in stage 121.

Next, parameters are set for how much could be saved given the parameters in stage 138. Optionally default parameters are set, such as max transfer amounts, min Source Account, balance parameters from the back end in stage 125. Again these may be based on predetermined defaults, on defaults which have appeal to other users, or perhaps to other users of similar demographic. In any case in stage 138, the app shows how much money can be saved given these parameters. Once the user has adjusted the parameters to his or her liking, parameters such as the max transfer amount, the minimum Source Account balance and other parameters are written to the back end in stage 122. Now the Source Account is linked in stage 139 and the Source Account information is linked to the back end in stage 123. This for example could be a checking account as the Source Account. Next the Target Account is linked in stage 135 and the Target Account information is written to the back end in stage 124. This for example could be perhaps a savings account, perhaps some account where the user is putting money aside to pay for student loans, or for any other purchases, that the user deems necessary.

FIG. 3B shows an initial user setup flow as a non-limiting example specific parameters. So stages 133 and 134 perform as previously described. Now the Spending Account is determined to be a credit card or perhaps one or more credit cards in stage 135 and so it's the credit card information that's written to the back end in stage 120. Recent spending is retrieved in stage 136, such as for example $500 for bars, $400 for groceries. Next, wasteful categories are defined. If the default wasteful categories in the back end are bars, fast food and movies in stage 126, then in stage 137, the app notes, that there are $500 of spending in these wasteful categories.

The user however may decide to only write the wasteful categories of bars and fast food to the back end in stage 121 and perhaps not movies. Next default parameters in the back end are obtained in stage 125. A max transfer amount of $20, a minimum Source Account balance of $500. In stage 138, according to these parameters, it would be shown that you would save $300 using these parameters. Now the parameters are written to the back end in stage 122 of the max transfer amount of $20, the minimum Source Account balance of $1,000. In this case the Source Account is determined to be a checking account in stage 139 and so this checking account information which is written to the back end in stage 123. The Target Account is determined to be a savings account in stage 140 and so the savings account information is written to the back end in stage 124.

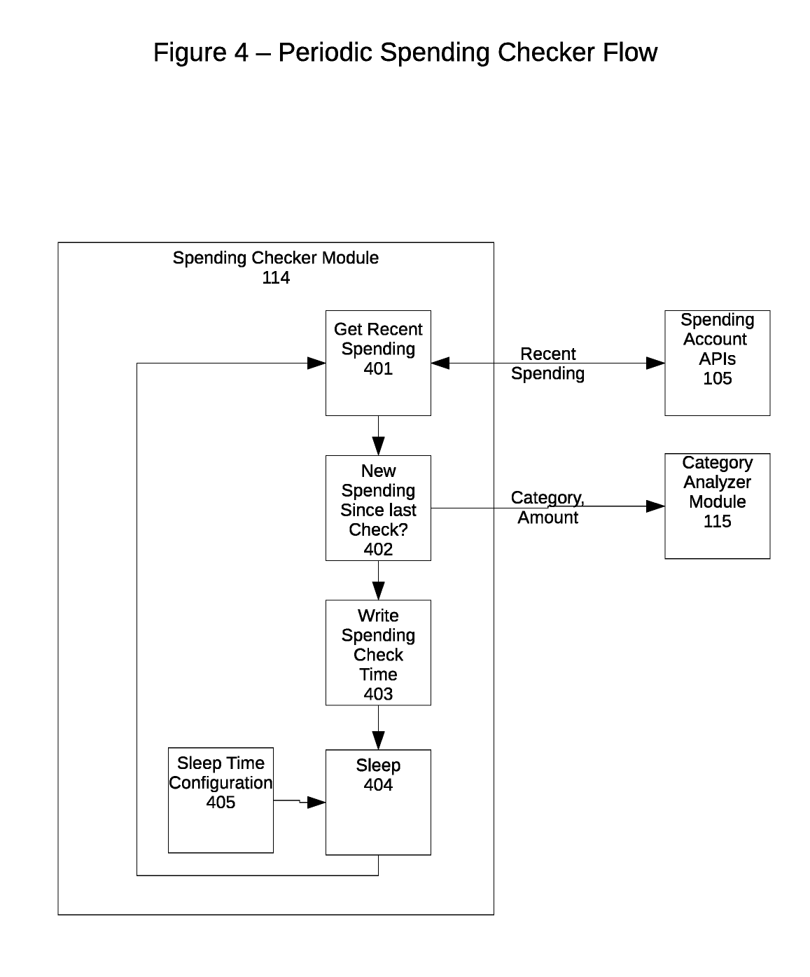

FIG. 4 shows a non-limiting exemplary periodic spending checker flow. For this process, the spending checker module performs the flow and starts the stage 401 by getting the recent spending, for example by doing a pull from Spending Account API 105. Next, the module checks for new spending since the last check in stage 402, according to the category amount. This information of new spending has been detected and the information of the category amount is sent to the category analyzer module 115. Next, the spending check time is written in 403 and the app goes back to sleep in 404. The sleep time configuration may optionally be set in stage 405, for example if the user would like the app to wake up more or less often or according to other parameters which may be set by the app, or alternatively by the source, target, or Spending Account APIs.

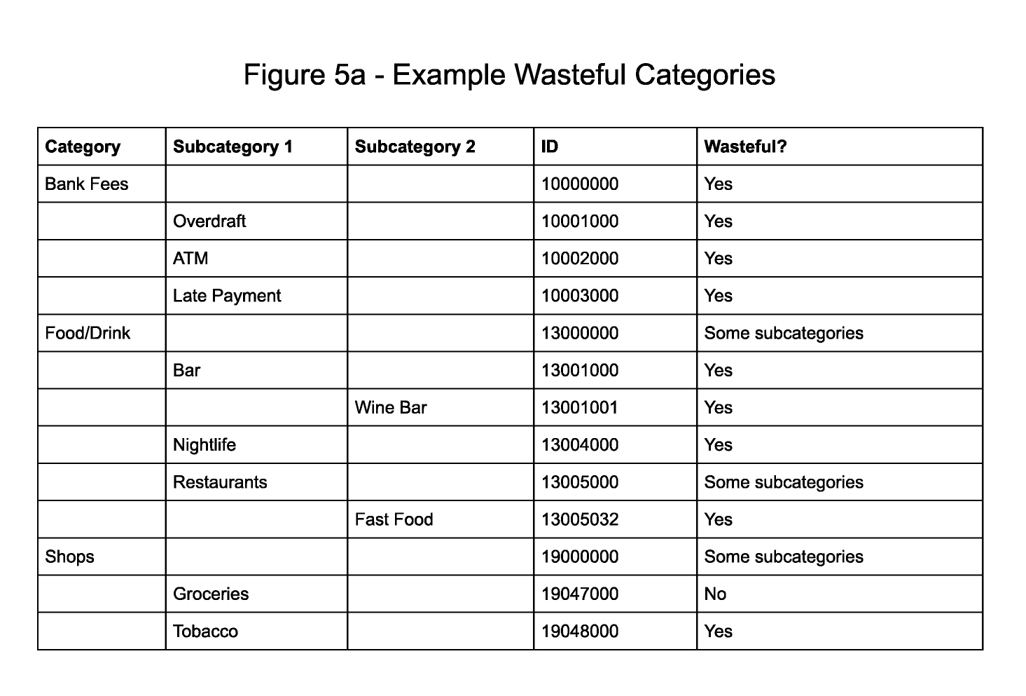

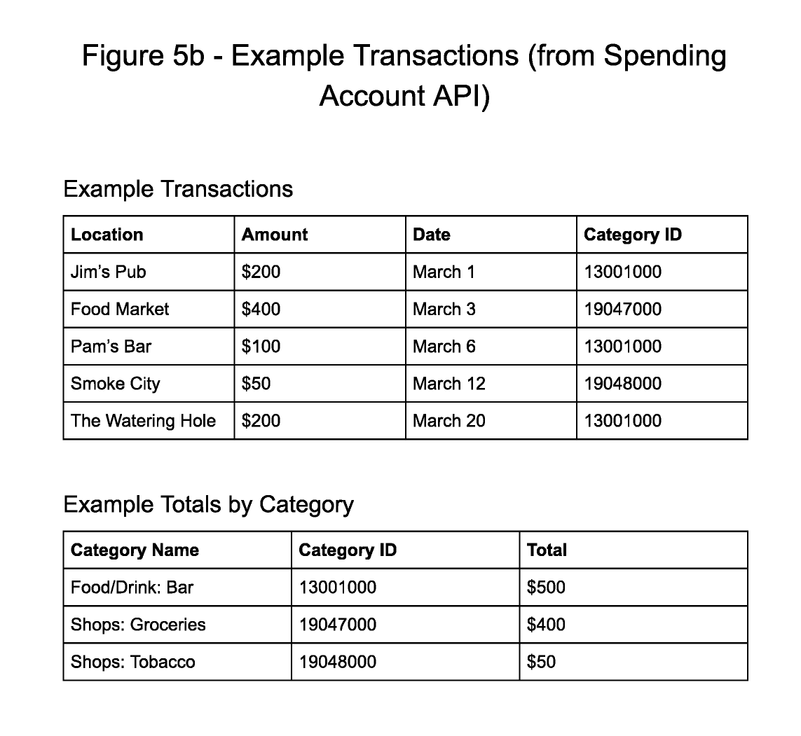

FIG. 5A shows an example of wasteful categories, such as for example, bank fees. In subcategory one, there are different types of bank fees, which may or may not be wasteful, such as overdraft, ATM and late payment.

These are given a particular ID number from the API, in this example the top ID shows the overall category and subcategory one has its own ID. Subcategory one ATM has another ID et cetera. This is all considered to be wasteful spending. In terms of food and drink, the overall category ID starts at 13 and only some subcategories are found to be wasteful. So for example a bar is always held to be wasteful, but there's a subcategory of a wine bar with a different number. Nightlife is considered to be wasteful, but restaurants are not always; only some subcategories are, such as for example fast food. And so forth and so forth and so on, for shops in which groceries are not wasteful but tobacco is.

FIG. 5B shows a non-limiting set of example transactions from the Spending Account API. For the example transactions, there are locations which are defined according to category IDs. So for example Jim's Pub, Pam's Bar and The Watering Hole have all previously been determined to be bars and they are given the bar category. Food Market is considered to be a grocery, it falls into the grocery category, but Smoke City falls into the tobacco category. So bars and tobacco are considered to be wasteful, groceries are not. In the example totals by category, we have food and drink bar, a wasteful category at $500, shops groceries a total of $400 and shops tobacco $50. So for these examples, $400 is not wasteful spending and $550 would be considered to be wasteful spending.

Any and all references to publications or other documents, including but not limited to, patents, patent applications, articles, webpages, books, etc., presented in the present application, are herein incorporated by reference in their entirety.

Example embodiments of the devices, systems and methods have been described herein. As noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and apparatuses which may further include any and all elements from any other disclosed methods, systems, and apparatuses, including any and all elements corresponding to target particle separation, focusing/concentration. In other words, elements from one or another disclosed embodiments may be interchangeable with elements from other disclosed embodiments. In addition, one or more features/elements of disclosed embodiments may be removed and still result in patentable subject matter (and thus, resulting in yet more embodiments of the subject disclosure). Correspondingly, some embodiments of the present disclosure may be patentably distinct from one and/or another reference by specifically lacking one or more elements/features. In other words, claims to certain embodiments may contain negative limitation to specifically exclude one or more elements/features resulting in embodiments which are patentably distinct from the prior art which include such features/elements.

What is claimed is:

1. A system for transferring a payment according to a spending pattern, comprising a user device, comprising a user software; a server for communicating with the user software; at least one source server capable of accessing a Source Account; at least one target server capable of accessing a Target Account; wherein said source server and said target server control accounts of the user; and a computer network for connecting said servers and said user device; wherein said server analyzes spending of the user according to said source server to determine the spending pattern, and induces said source server to transfer payment from said Source Account to said Target Account through said target server.

2. A method for transferring a payment according to a spending pattern, the method being performed by the system of claim 1, the method being operated by a remote computational device, the method comprising determining the spending pattern of the user according to at least one category of wasteful spending, wherein said at least one category of wasteful spending is determined by the user through said user software, and wherein said transfer payment is proportional to an amount spent in said category of wasteful spending.

3. A method for inducing a user to change a spending habit, the method being performed by a remote computational device, the method comprising providing a user software being operated by a user computational device; connecting the remote computational device to at least one source server capable of accessing a Source Account and to at least one target server capable of accessing a Target Account; analyzing user spending patterns by the remote computational device according to information retrieved from the Source Account; determining a spending pattern of at least one category of spending by the user as being wasteful; and transferring a sum from said Source Account to said Target Account according to said spending pattern.

4. The system or method of any of the above claims, wherein said Source Account comprising a credit card, a debit card, a savings account or checking account.

5. The system or method of any of the above claims, wherein said Target Account comprises a savings account, a checking account, a brokerage account, a retirement account, a loan or a credit card.
